(19) United States
(12) Patent Application Publication
(10) Pub. No.: US 2025/0003271 A1
(43) Pub. Date: Jan. 2, 2025

(54) Improved High Security Hasp for Hidden Shackle Lock

(71) Applicant: Corbas Marketing, Inc., North Hollywood, CA (US)

(72) Inventors: Carlos Cordova, North Hollywood, CA (US); Sammy Vargas, North Hollywood, CA (US)

(21) Appl. No.: 18/886,675

(22) Filed: Sep. 16, 2024

Related U.S. Application Data
(63) Continuation-in-part of application No. 18/126,305, filed on Mar. 24, 2023.

(51) Int. Cl. E05C 19/08; E05B 67/22

(52) U.S. Cl. CPC E05C 19/08; E05B 67/22

(57) ABSTRACT

An improved hasp for use with a hidden shackle pad lock. The hasp is manufactured of high strength steel and includes a tamper proof hinge with a domed pin. Further the shackle is mounted on high strength laminated steel mounting plates for additional security. The device includes a protective shroud for the hidden shackle lock with offset breaks in the shroud to prevent cutting the lock with a grinder. Further the configuration of the shackle allows use on openings that need to be secured, particularly those on boxes for public utilities (utility boxes).

### PRIORITY CLAIM

This application claims priority to as a continuation-in-part of U.S. patent application Ser. No. 18/126,305 filed on Mar. 24, 2023.

### BACKGROUND OF THE INVENTION

### Field of the Invention

This invention relates to a high security hasp that couples with a lock to secure cabinets, utility cabinets, doors, openings or other locked areas. A hasp is formed of metal plates that are fastened together with a lock to secure a door or an opening. These doors or openings may be on any opening, doorway, cabinet, or any device that needs to be secured by a lock.

The shackle of a padlock is a bar that is locked/secured to the body of the lock when in the locked position and unsecured/free from the lock in the unlocked position. In a typical padlock, the shackle is a U-shaped bar that loops around from one side of the padlock to the other. When the padlock is locked, the U-shaped shackle is secured to both sides of the lock. When the padlock is unlocked, the U-shaped shackle is free from one side of the lock so that the padlock can be removed from the hasp.

A hasp for a typical padlock with a U shaped exposed shackle includes two metal plates, with each of the metal plates attached to one side of the door or opening to be secured. This type of hasp generally has a first metal plate with a raised loop that fits through a complementary slot on the second metal plate. The shackle of the pad lock fits through the loop and once the pad lock is locked, the shackle prevents moving the raised loop of the first plate through the complementary slot of the second metal plate. This secures the first metal plate to the second plate.

A second type of padlock is a hidden shackle pad lock. This type of pad lock is sometimes referred to “puck” type pad locks. This type of lock is round, with a key hole on the vertical side of the lock. In this type of lock, the shackle is hidden in a compartment on the rear side of the lock. The shackle comprises a straight bar that is secured to both sides of the lock in the locked position. In the unlocked position, the shackle retracts into the body of the lock. In a typical padlock, the U-shaped shackle is a weak point and can be cut more easily than the body. With a hidden shackle padlock, the shackle is hidden behind the body of the lock. Hidden shackle padlocks are typically made of hardened steel that is difficult to cut. This configuration makes hidden shackle padlocks more difficult to cut and thus more secure.

A second type of hasp is secured by a hidden shackle pad lock. This second type of hasp has a first raised metal tab and a second raised metal tab, each with a circular opening through the tab. The tabs are sized to fit in the compartment at the rear of a hidden shackle lock, the circular openings sized such that the shackle of a hidden shackle pad lock with fit through them and the tabs oriented such that when the shackle is routed through the circular openings and locked, that the lock secures the first raised metal tab to the second raised metal tab. Securing the first raised metal tab to the second raised metal tab secures the two sides of any opening that needs to be secured.

Hasps are generally manufactured of high strength steel but can also be made of stainless steel, aluminum, or cast iron.

Prior art hasps designed to be used with hidden shackle have a variety of shortcomings including that they can be easily removed from a door/opening or may be cut in half to separate the two halves of the hasp.

### SUMMARY OF THE INVENTION

The present invention is an improved hasp for use with a hidden shackle pad lock. The improved device is manufactured of high strength steel and includes a tamper proof hinge with a domed pin. Further the shackle is mounted on high strength laminated steel mounting plates for additional security. The device includes a protective shroud for the hidden shackle lock with offset breaks in the shroud to prevent cutting the lock with a grinder. Further the configuration of the shackle allows use on openings that need to be secured, particularly those on boxes for public utilities (utility boxes).

A second embodiment of the invention includes first and second securing plates formed of thick, high strength steel, with the hinge build into each directly both securing plates for added strength.

### BRIEF DESCRIPTION OF THE DRAWINGS

FIG. 1 is a view of a prior art hasp for a pad lock with a U shaped shackle.

FIG. 2 is a front and rear view of a hidden shackle pad lock.

FIG. 3 is a view of the improved hasp secured on a utility box.

FIG. 4 is a detailed perspective view of the improved hasp secured with a hidden shackle padlock.

FIG. 5 is a detailed perspective view of the improved hasp secured without a hidden shackle padlock installed.

FIG. 6 is top view of the improved hasp.

FIG. 7 is a front view of the improved hasp.

FIG. 8 is a side view of the improved hasp.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application.

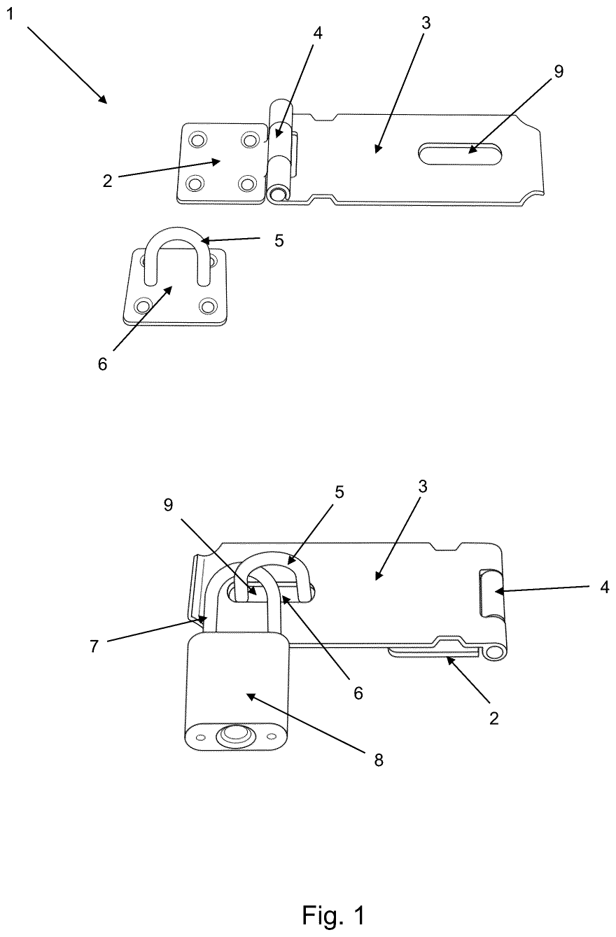

FIG. 1 is a view of a prior art hasp 1 to be used with a U shaped shackle type pad lock 8. Prior art hasp 1 secures a first side of an opening to a second side of an opening. Such an openings could include a door, a cabinet door or any other opening that needs to be secured with a pad lock.

First securing plate 2 is attached to one side of the opening to be secured. First securing plate 2 is attached to hinge 4 that is connected to first plate 3. First plate 3 includes slot 9 that is sized to fit over loop 5 which is connected to second securing plate 6. Second securing plate 6 is attached to the other side of the opening to be secured with the hasp 1 and pad lock 8. Loop 5 fits through slot 9 with U shaped shackle 7 of pad lock 8 routed through loop 5. When pad lock 8 is locked, U shaped shackle 8 is locked into place, thus securing loop 5 and second securing plate 6 to first plate 3 and first securing plate 2. When this process is complete, the first side of an opening is secured to the second side of that opening with pad lock 8.

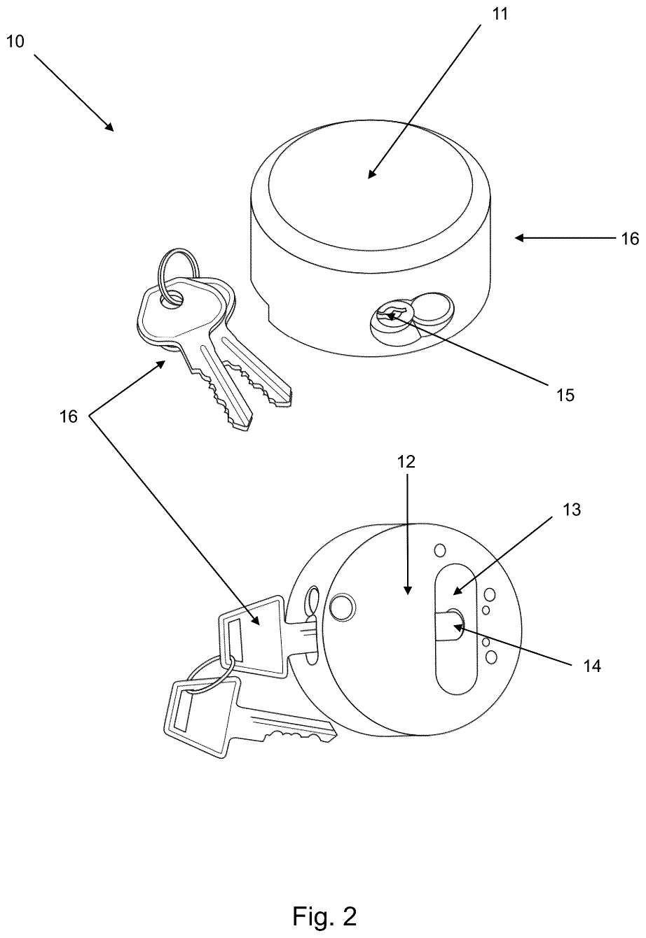

FIG. 2 is a view of the front and back of a hidden shackle pad lock 10. Front side 11 is the portion of the lock that is visible when the lock is attached and locked to a hasp. The vertical side 16 of pad lock 10 contains key hole 15. Key 16 is rotated in key hole 15 to lock and unlock pad lock 10. Rear side 12 of pad lock 10 contains compartment 13 with containing shackle 14. Shackle 14 is shown in the locked position. In the unlocked position, shackle 14 retracts into the body of pad lock 10.

Hidden shackle pad lock 10 provides improved security because the normally vulnerable shackle 14 is hidden behind the body of pad lock 10. Typically, U shaped shackle 7 of pad lock 8 is the targeted for cutting by thieves. Because shackle 14 of hidden shackle pad lock 10 is hidden behind the substantial body of pad lock 10, it is very difficult to access and cut. Hidden shackle pad lock 10 is often made of high strength metal, specifically high strength steel that is difficult to cut, even with power tools. The length of time it takes to cut through the body of pad lock 10 and the noise generated by the tools necessary to perform such cutting exposes thieves to detection and capture. This additional body strength and hidden shackle, make hidden shackle pad lock 10 more secure that pad lock 8 with U shaped shackle 7.

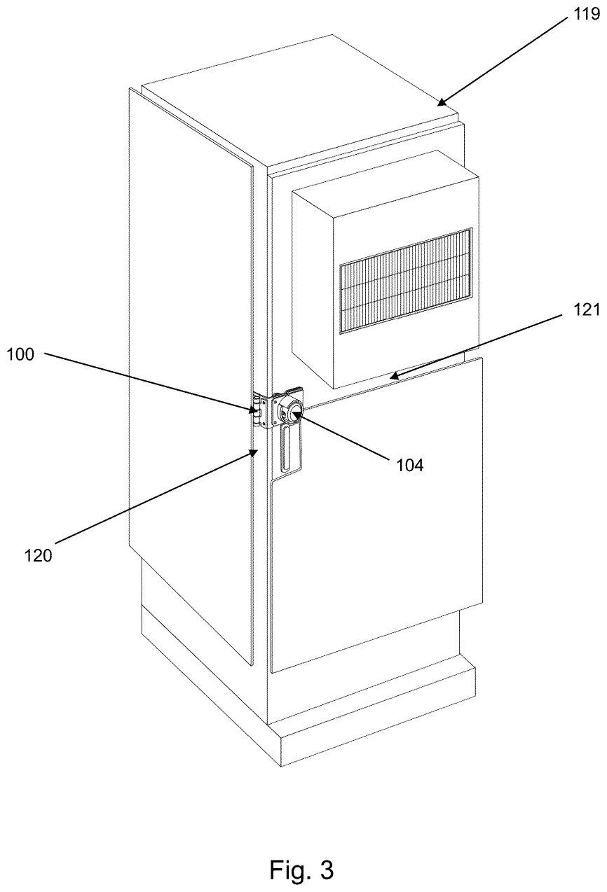

FIG. 3 shows the improved high security hasp 100 installed on a utility cabinet 119. In this view, hasp 100 is installed between the utility cabinet side 120 and utility cabinet door 121. Pad lock 104 is shown locked in place on hasp 100.

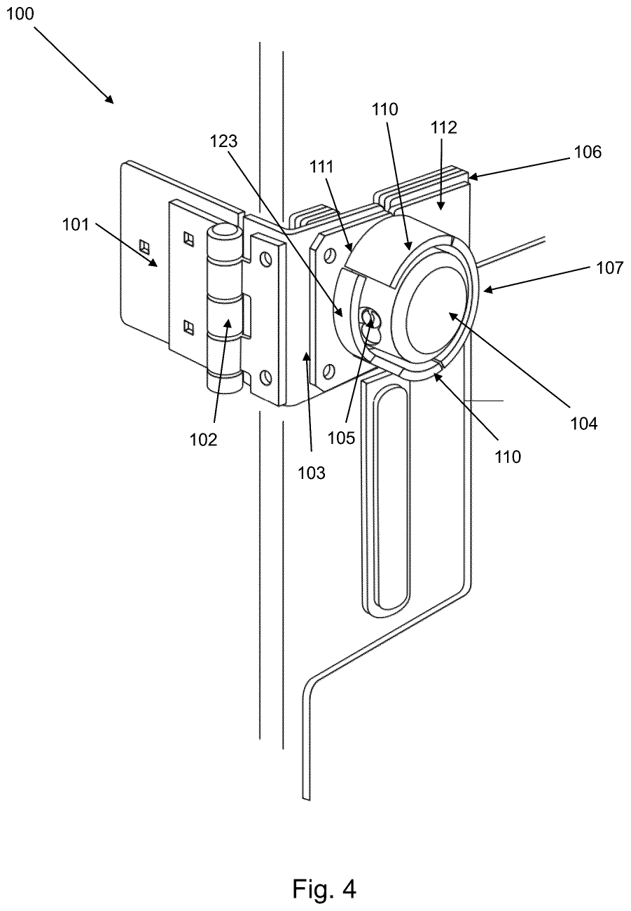

FIG. 4 shows a detailed view of high security hasp 100 installed on a utility cabinet with pad lock 104 locked in place. Hasp 100 is comprised of first securing plate 101, hinge 102, second securing plate 103 and third securing plate 106. In this view, hasp 100 is shown with hidden shackle pad lock 104 installed with pad lock front side 109 shown. Pad lock 104 includes key hole 105 on the vertical side wall of pad lock 104. In the preferred embodiment, first securing plate 101 is attached to utility cabinet side wall with a carriage bolt and is formed of high strength steel.

Hinge 102 is attached to one end of first securing plate 101 and to one end of second securing plate 103. Hinge 102 is a high security hinge with a domed pin that is difficult to cut with a grinder or other power tool. In the preferred embodiment, hinge 102 is made of high strength steel and securely welded to first securing plate 101 and second securing plate 103. Welding is used in the preferred embodiment, but any method of connection well known in the art could be used such as casting or forging. Hinge 102 could be formed as a portion of both first securing plate 101 and/or second securing plate 103.

In the preferred embodiment, second securing plate 103 is L shaped with a right angle in the plate that allows the hinge to be positioned along the utility cabinet side 120 while attached to one side of second securing plate 103 while the front side of the second securing plate 103 is oriented along the utility cabinet door 121. First lock base 111 is attached to second securing plate 103. First lock base 111 comprises the first raised vertical tab to couple with the shackle of pad lock 104. First lock base 111 also comprises first lock shroud 110. First lock shroud 110 is a semi-circular raised shroud that provides additional protection from cutting for pad lock 104. The edges of first lock shroud 110 tightly couple with complementary edges of second lock shroud 107, which is attached second lock base 112 which is positioned on third securing plate 103. Second lock base 112 includes a second raised vertical tab that couples with the shackle of pad lock 104 to secure first lock base 111 and second lock base 112 to each other. In the preferred embodiment, first lock base 111 and second lock base 112 are welded securely to second securing plate 103 and third securing plate 106. When compartment 13 of pad lock 104 is positioned over the raised vertical tabs of first lock base 111 and second lock base 112 and the shackle is routed through the tabs, second securing plate 103 is locked securely to third securing plate 106. This locked position securely locks utility cabinet door 121 closed.

As an additional security measure, third lock shroud 123 provides protection against accessing the rear of lock 104. Third lock shroud 123 has a reduced wall height, to provide access to key hole 105. However, third lock shroud 123 has wall height sufficient to guard against a thief lifting lock 104 to gain access to the rear of the lock. Third lock shroud 123 prevents lifting lock 104 to gain access to the rear of lock 104. This provides additional protection from prying lock 104 away from hasp 100. The combination of first lock shroud 110, second lock shroud 107, and third lock shroud 123 provide 360 degree protection for lock 104 to fortify hasp 100 against cutting or prying of lock 104.

The components of improved security hasp 100 including first securing plate 101, hinge 102, second securing plate 103, first lock base 111, second securing plate 106, second lock base 112, first lock shroud 110 and second lock shroud 107 are made of high strength steel in the preferred embodiment. The components may be cast, forged or cut with a variety of methods to form the items. While high strength steel is used in the preferred embodiment, other materials may be utilized such as stainless steel, aluminum, cast iron or any other high strength material known in the art. Manufacturing methods such as casting, forging, welding, CNC cutting and plasma cutting may be used in the manufacture of each of the component parts.

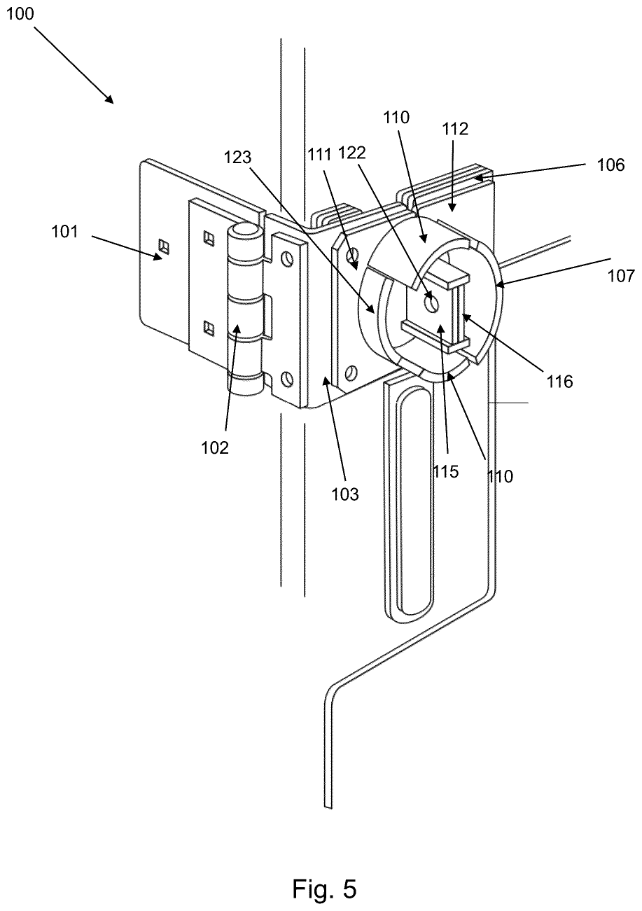

FIG. 5 shows improved security hasp 100 without pad lock 104 attached. In this view all the constituent components show in FIG. 3 are included. Further, the first raised vertical tab 115 of first lock base 111 and second raised vertical tab 116 of second lock base 112 are visible. First raised vertical tab 115 and second raised vertical tab 116 include shackle slots 122 designed to fit the shackle 14 of pad lock 104. The shackle of pad lock 104 fits through each of the shackle slots 122 and when locked, secure first lock base 111 and second lock base 112 and thus second securing base 103 and third securing base 106 to each other. Locking second securing lock base 103 to third securing lock base 106 allows the door of utility cabinet to be secured to the side wall of utility cabinet.

As an additional security measure, third lock shroud 123 provides protection against accessing the rear of lock 104. Third lock shroud 123 has a reduced wall height, to provide access to key hole 105. However, third lock shroud 123 has wall height sufficient to guard against a thief lifting lock 104 to gain access to the rear of the lock. Third lock shroud 123 prevents lifting lock 104 to gain access to the rear of lock 104. This provides additional protection from prying lock 104 away from hasp 100. The combination of first lock shroud 110, second lock shroud 107, and third lock shroud 123 provide 360 degree protection for lock 104 to fortify hasp 100 against cutting or prying of lock 104.

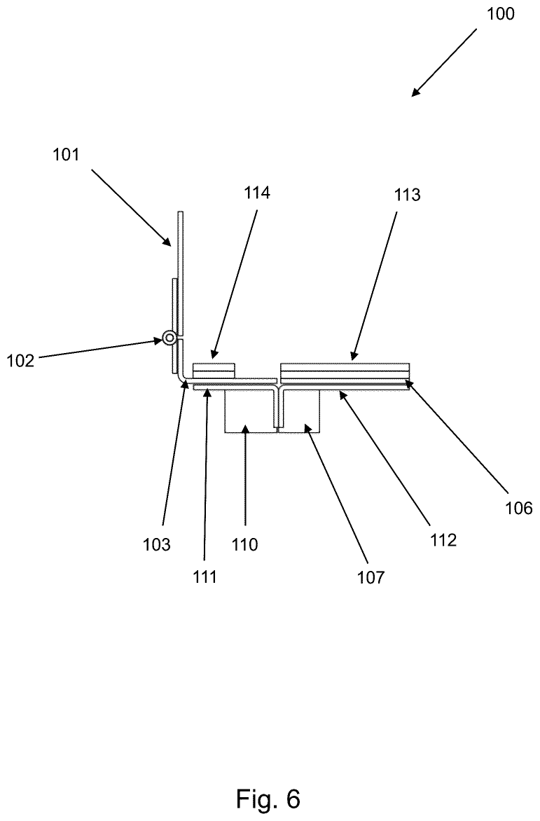

FIG. 6 shows a top view of improved security hasp 100. In this view, first securing plate 101, hinge 102, second securing plate 103, first lock base 111, first lock shroud 110, second lock base 112, second lock shroud 107 and third securing plate 106 are shown as described in relation to FIGS. 3 and 4. Also shown in this figure are first security base 114 and second security base 114. First security base 114 and second security base 113 are stacked, laminated high strength steel that provide security support for improved security hasp 100. First security base 114 provides additional laminated high strength steel support for the improved security hasp 100 at a potential weak point, making it much more difficult to break apart or cut with existing tools. Second security base 113 provides a high strength mounting point for third securing plate 106. First security base 114 and second security base 113 are made of stacked, laminated high strength steel, making them very difficult to cut or drill. While in the preferred embodiment, they are made of high strength steel, any high strength material such as stainless steel, aluminum, or cast iron.

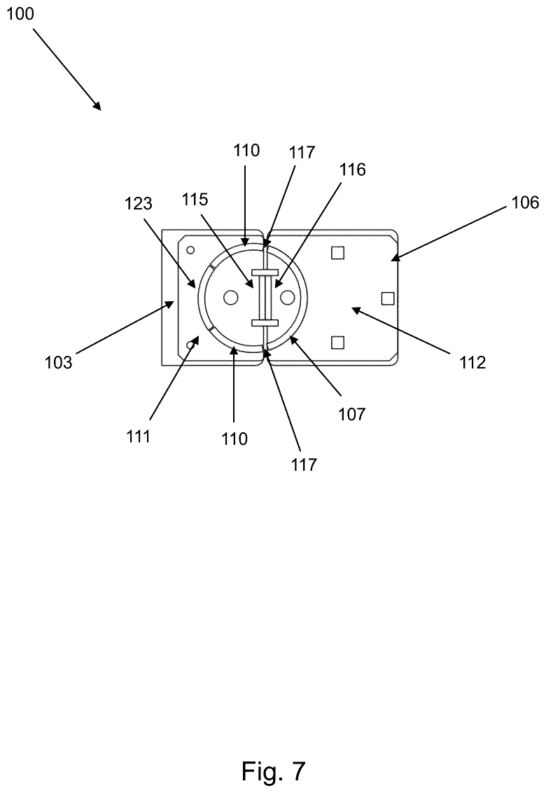

FIG. 7 is a front view improved security hasp 100. In this view, the orientation of first lock shroud 110 and second lock shroud 107 is shown. Here, shroud gaps 117 are directly across from each other, i.e. a straight line could be drawn from one gap to the other. In other embodiments, the shroud gaps can be offset, meaning that a straight line drawn from the first gap would not intersect with the second gap. Offset shroud gaps 117 provide an additional layer of security. A thief attempting to use a grinder or other cutting tool to cut through a hidden shackle lock may attempt to start such a cut in the lock shroud gap 117. If the lock shroud gap 117 are offset, any cut through one gap will intersect with the other side of the lock shroud, i.e., not with the opposite shroud gap 117. This requires additional cutting through high strength steel. This cutting is time consuming and generates significant noise, so any additional time required increases a thief's risk of detection in the act, thus improving the security of the device.

Also shown are first raised vertical tab 115 and second raised vertical tab 116. These tabs are oriented to fit in the compartment 13 of pad lock 104 and to couple with shackle 14 of the lock. First raised vertical tab 115 and second raised vertical tab 116 are oriented across from each other so that the shackle 14 can be routed through the shackle slots 122 in the tabs.

As an additional security measure, third lock shroud 123 provides protection against accessing the rear of lock 104. Third lock shroud 123 has a reduced wall height, to provide access to key hole 105. However, third lock shroud 123 has wall height sufficient to guard against a thief lifting lock 104 to gain access to the rear of the lock. Third lock shroud 123 prevents lifting lock 104 to gain access to the rear of lock 104. This provides additional protection from prying lock 104 away from hasp 100. The combination of first lock shroud 110, second lock shroud 107, and third lock shroud 123 provide 360 degree protection for lock 104 to fortify hasp 100 against cutting or prying of lock 104.

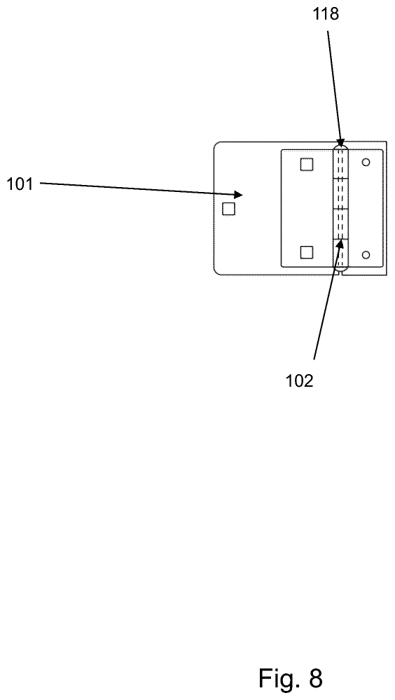

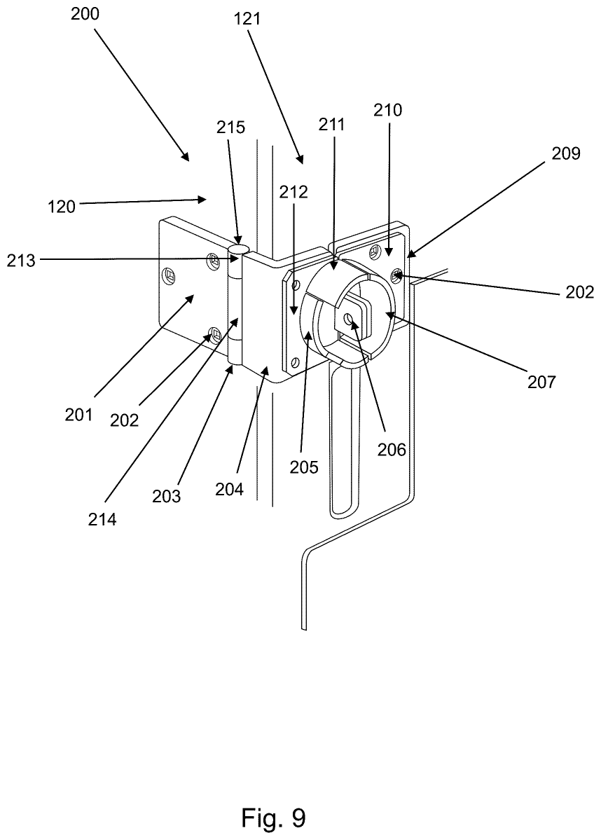

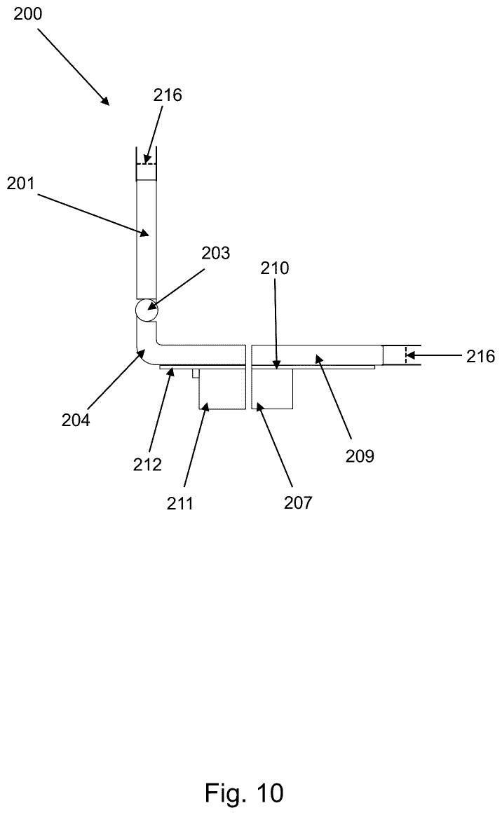

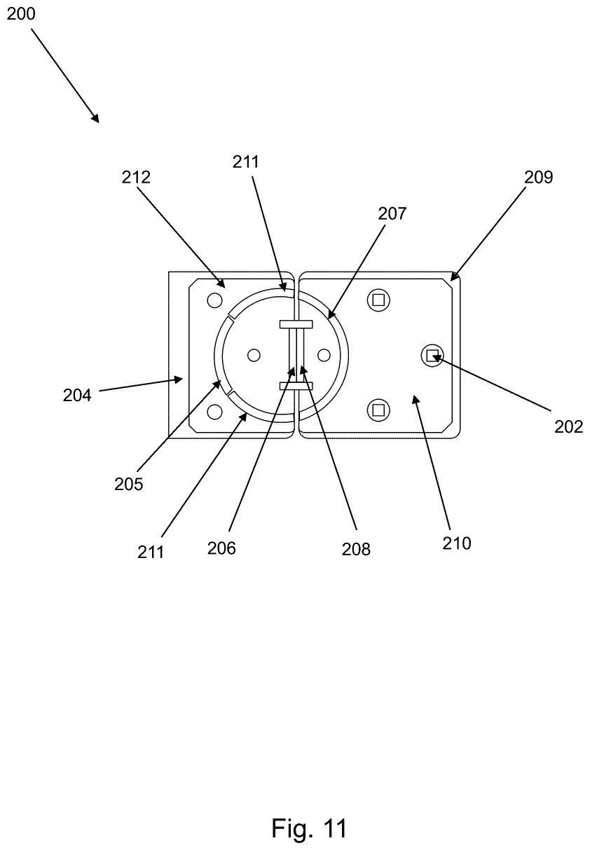

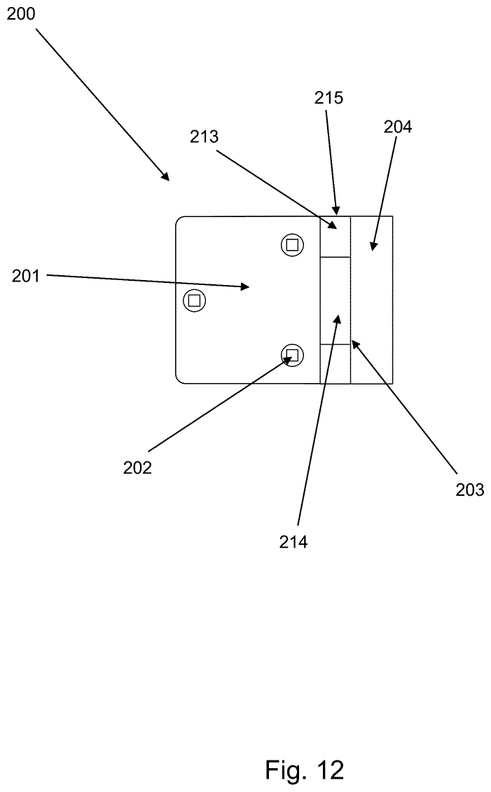

FIG. 8 is a side view of the hinge side of the improved security hasp 100. In this view, the first mounting plate 101 is visible in relation to hinge 102. Hinge 102 is welded to first mounting plate 101 using welding methods well known in the art. First mounting plate 101 is attached to the side of a utility cabinet (or any cabinet type opening secured by a door) using attachment methods well known in the art. In the preferred embodiment, first mounting plate 101 is mounted to the side wall of the utility cabinet using a carriage bolt.

Hinge 102 is an antitheft hinge with domed pin 118. The domed top of the hinge, made from hardened steel makes it very difficult to cut with a grinder or other methods, thus improving the security.

FIG. 9 shows a second embodiment of improved security hasp 200. In this embodiment, first securing plate 201 is formed of a single piece of thick high strength steel. This thick high strength steel is extremely difficult and time consuming to cut. Second securing plate 204 is also formed of a single piece of thick high strength steel bent at an approximately 90 degree angle to so that one side may be fitted to utility cabinet side 120 and the other side of the angle can be fitted to utility cabinet door 121. This embodiment is described in relation to a utility cabinet, but improved security hasp 200 and second securing plate 204 may utilized with any item that needs to be locked shut.

In this embodiment of improved security hasp 200, hinge 203 is formed in two separate sections: first hinge knuckle 213 and second hinge knuckle 214. First hinge knuckle 213 is formed as a part of first securing plate 201. Second hinge knuckle 214 is formed as part of second securing plate 204. Both first hinge knuckle 213 and second hinge knuckle 214 are formed of essentially circular parts with a central round shaped void. First hinge knuckle 213 and second hinge knuckle 214 are formed to couple with the central round void aligned. Pin 215 fits through the central round void of first hinge knuckle 213 and second hinge knuckle 214 to couple the hinge knuckles together. The formation of first hinge knuckle 213 to first securing plate 201 and second hinge knuckle 214 to second securing plate 204 improves security by making the hinge more difficult to break. In some embodiments first hinge knuckle 213 and second hinge knuckle may be welded to first securing plate 201 and second securing plate 204.

First lock base 212 is attached to second securing plate 204. First lock base 212 comprises the first raised vertical tab to couple with the shackle of pad lock 104. First lock base 212 also comprises first lock shroud 210. First lock shroud 210 is a semi-circular raised shroud that provides additional protection from cutting for pad lock 104. The edges of first lock shroud 210 tightly couple with complementary edges of second lock shroud 207, which is attached second lock base 210 which is positioned on third securing plate 209. Second lock base 210 includes a second raised vertical tab that couples with the shackle of pad lock 104 to secure first lock base 211 and second lock base 207 to each other. In the preferred embodiment, first lock base 212 and second lock base 210 are welded securely to second securing plate 204 and third securing plate 209. When compartment 13 of pad lock 104 is positioned over the raised vertical tabs 206 of first lock base 212 and second lock base 207 and the shackle is routed through the tabs, second securing plate 204 is locked securely to third securing plate 209. This locked position securely locks utility cabinet door 121 closed.

Recessed bolt receptacles 202 are formed on first securing plate 201 and third securing plate 209 to facilitate attachment of each to the cabinet wall 120 or cabinet door 121 respectively. Rivets or bolts may be routed through recessed bolt receptacles 202 to firmly attach first securing plate 201 to cabinet wall 120 and second third securing plate 209 to cabinet door 121. The recessed nature of recessed bolt receptacles 202 allows the head of the bolt or rivet to be flush with the surface of first securing plate 201 and third securing plate 209 making cutting the head of the bolt or rivet very difficult.

First securing plate 201 and second securing plate 204 are formed of high strength steel of a specific thickness by casting, forging and/or milling. Other methods of manufacture of the component parts include casting, forging, welding, CNC cutting and plasma cutting. Any high strength material well known in the art may be utilized including such as stainless steel, aluminum, or cast iron.

FIG. 10 shows a top view of improved security hasp 200. In this view, first securing plate 201, hinge 203, second securing plate 204, first lock base 212, first lock shroud 211, second lock base 210, second lock shroud 207 and third securing plate 209 are shown as described in relation to FIG. 9. Also shown in this figure are the thickness of first securing plate 201, second securing plate 204 and third securing plate 209. The dimension of this thickness is shown by thickness 216. In the preferred embodiment is 0.5 inches. The key feature of this embodiment is use of a thick steel plate of around 0.5 inches to make drilling and cutting of the first securing plate 201, second securing plate 204 and third securing plate 209 very difficult thus improving security. While in the preferred embodiment first securing plate 201, second securing plate 204 and third securing plate 209 are made of high strength steel, any high strength material such as stainless steel, aluminum, or cast iron may be utilized.

FIG. 11 is a front view improved security hasp 200. In this view, the orientation of first lock shroud 211 and second lock shroud 207 is shown. Also shown are first raised vertical tab 206 and second raised vertical tab 208. These tabs are oriented to fit in the compartment 13 of pad lock 104 and to couple with shackle 14 of the lock. First raised vertical tab 206 and second raised vertical tab 208 are oriented across from each other so that the shackle 14 can be routed through shackle slots in each of the tabs. This is similar in function to the operation described above in relation to FIGS. 5-7.

As an additional security measure, third lock shroud 205 provides protection against accessing the rear of lock 104. Third lock shroud 205 has a reduced wall height, to provide access to key hole 105. However, third lock shroud 205 has wall height sufficient to guard against a thief lifting lock 104 to gain access to the rear of the lock. Third lock shroud 205 prevents lifting lock 104 to gain access to the rear of lock 104. This provides additional protection from prying lock 104 away from hasp 200. The combination of first lock shroud 211, second lock shroud 207, and third lock shroud 205 provide 360 degree protection for lock 104 to fortify hasp 200 against cutting or prying of lock 104.

FIG. 12 is a side view of the hinge side of the improved security hasp 200. In this view, the first securing plate 201 is visible in relation to hinge 203. Hinge 203 is formed in two separate sections: first hinge knuckle 213 and second hinge knuckle 214. First hinge knuckle 213 is formed as a part of first securing plate 201. Second hinge knuckle 214 is formed as part of second securing plate 204. Both first hinge knuckle 213 and second hinge knuckle 214 are formed of essentially circular parts with a central round shaped void. First hinge knuckle 213 and second hinge knuckle 214 are formed to couple with the central round void aligned. Pin 215 fits through the central round void of first hinge knuckle 213 and second hinge knuckle 214 to couple the hinge knuckles together. The formation of first hinge knuckle 213 to first securing plate 201 and second hinge knuckle 214 to second securing plate 204 improves security by making the hinge more difficult to break. In some embodiments, both first securing plate 201/first hinge knuckle 213 and second securing plate 204/second hinge knuckle 214 are formed of a single piece of cast, forged or milled high strength steel. In other embodiments, first hinge knuckle 213 and second hinge knuckle may be welded to first securing plate 201 and second securing plate 204, respectively.

First securing plate 201 is attached to the side of utility cabinet 120 (or any cabinet type opening secured by a door) using attachment methods well known in the art such as rivets, bolts or welds, through recessed bolt receptacles 202 as discussed in relation to FIG. 9. In the preferred embodiment, first securing plate 201 is mounted to the side wall of the utility cabinet 120 using a rivet with a top flush with the surface of first securing plate 201.

Although the present invention has been described in relation to the above disclosed preferred embodiment, many modifications in design, implementation, systems and execution are possible while still maintaining the novel features and advantages of the invention. The preferred embodiment is not meant to limit the scope of the patent in any way, and it should be given the broadest possible interpretation consistent with the language of the disclosure on the whole.

1. A hasp for coupling an opening with a first side and a second side, where the first side is secured to the second side with a hidden shackle padlock, the hasp comprising:
a first securing plate with a specified thickness and comprising a first hinge knuckle, the first securing plate for securing the hasp to the first side of the opening to be secured;
a second securing plate with a specified thickness and comprising a second hinge knuckle;
a pin routed through the first hinge knuckle and the second hinge knuckle, the pin coupling the first hinge knuckle to the second hinge knuckle;
a first lock base positioned on the second securing plate, where the first lock base comprises a first lock shroud and a first raised vertical tab, and where the first raised vertical tab comprises a first shackle slot for coupling with shackle of the pad lock; and
a third securing plate with a specified thickness for securing the hasp to the second side of the opening to be secured, the third securing plate comprising a second lock base, where the second lock base comprises a second lock shroud and a second raised vertical tab, and where the second raised vertical tab comprises a second shackle slot for coupling with the shackle of the pad lock, where the first side of the opening is secured to the second side of the opening when the shackle of the pad lock is coupled with the first shackle slot and the second shackle slot and placed in a locked position.

2. The hasp of claim 1 where the specified thickness is equal or greater than 0.5 inches.

3. The hasp of claim 1 wherein the second securing plate further comprises a third lock shroud.

4. The hasp of claim 1 where the first securing plate and first hinge knuckle are formed of a single piece of high strength steel.

5. The hasp of claim 1 where the second securing plate and second hinge knuckle are formed of a single piece of high strength steel.

6. The hasp of claim 1 where first hinge knuckle is attached to first securing plate by welding.

7. The hasp of claim 1 where second hinge knuckle is attached to second securing plate by welding.

8. The hasp of claim 1 where the hasp is made from a material selected from the group comprising high strength steel, stainless steel, aluminum, and cast iron.

9. The hasp of claim 1 where the hasp is manufactured using a method selected from the group comprising casting, molding, forging, welding, and CNC cutting.
